(19) United States
(12) Patent Application Publication
(10) Pub. No.: US 2016/0191218 A1
(43) Pub. Date: Jun. 30, 2016

(54) METHODS AND APPARATUS FOR FASTER THAN NYQUIST RATE MULTI-CARRIER MODULATION

(71) Applicant: INTERDIGITAL PATENT HOLDINGS INC., Wilmington, DE (US)

(72) Inventors: Erdem Bala, Melville, NY (US); Rui Yang, Melville, NY (US); Jialing Li, San Diego, CA (US)

(21) Appl. No.: 14/912,337

(22) PCT Filed: Aug. 15, 2014
(86) PCT No.: PCT/US2014/051228

§ 371 Date: Feb. 16, 2016

Related U.S. Application Data
(60) Provisional application No. 61/871,559, filed on Aug. 29, 2013.

(51) Int. Cl. H04L 5/00; H04L 27/26; H04J 11/00

(52) U.S. Cl. CPC H04L 5/0007; H04J 11/0023; H04L 27/2644

(57) ABSTRACT

The disclosure pertains to methods and apparatus for Faster than Nyquist (FTN) modulation schemes to increase throughput in multicarrier communication systems and wherein the latency problem inherent in filter bank multicarrier systems (FBMC) is reduced or eliminated by using non-orthogonal waveforms (i.e., faster than Nyquist modulation) in only part(s) of the subframe or packet and orthogonal waveforms in other part(s). The number and spacing between FTN pulses may be selected such that the last sample of the last pulse is received within the time slot allocated to the subframe/packet, thereby eliminating added latency. The FTN modulation scheme may be employed both temporally and in frequency (e.g., the frequency spacing of the channels may be tighter than the Nyquist frequency spacing condition. FTN signaling also may be used as a method to control/coordinate interference between different nodes. For instance, if a node uses FTN, more pulses may be packed into a given period in the time domain and/or more channels may be packed into a given bandwidth in the frequency domain, hence some parts of the band may be vacated for use by others, use by the same node for additional channels, or used with reduced power. The interference control/coordination may be extended to time and frequency. Such FTN schemes may be used with different types of multicarrier systems.

### RELATED APPLICATIONS

This application claims priority to U.S. Provisional Patent Application No. 61/871,559 filed Aug. 29, 2013 entitled Methods and Apparatus for Faster than Nyquist Rate Multi-Carrier Modulation, the contents of which are incorporated herein fully.

### FIELD OF THE INVENTION

This application relates to techniques for faster-than-Nyquist rate (FTN) modulation schemes. More particularly, this application relates to techniques for reducing latency in filter bank multicarrier modulation schemes and reducing interference in FTN modulation schemes.

### BACKGROUND

Multicarrier modulation (MCM) is based on the splitting of a high-rate wideband signal into lower-rate signals where each signal occupies a narrower bandwidth, called the subchannel. Orthogonal frequency division multiplexing (OFDM) has proved itself as one of the most popular MCM techniques, and is currently used in many wireless communication systems, such as 3GPP Long Term Evolution (LTE), and IEEE 802.11.

As an alternative to OFDM, filter bank multicarrier (FBMC) modulation schemes, specifically OFDM-Offset QAM (OFDM-OQAM), have recently received attention. A FBMC system is a filter bank in a transmultiplexer configuration. Transmultiplexers (a synthesis-analysis configuration) have synthesis filter banks (SFBs) as transmitters and analysis filter banks (AFBs) as receivers. In the synthesis filter banks, parallel signals are filtered after being upsampled and summed to form a composite signal. The filters are designed appropriately so that side lobes are significantly reduced. In general, a FBMC can be expressed as a general N-channel, L-decimated filter bank structure in discrete time model, such as shown in one possible simplified form in FIG. 1. At the transmitter 11, data symbols 12 to be transmitted on the k^{th} sub-channel are upsampled in upsamplers 13 and filtered by filters 14. The outputs from all filters 14 are added in adder 15 and the signal delayed in delay circuit 16 to form the transmitted signal. At the receiver 19, the received signal is demultiplexed into M subchannels, filtered in analysis filters 17, and downsampled by downsamplers 23 to generate the estimate of the data symbols 25.

OFDM-OQAM (Orthogonal Frequency Division Multiplexing-Offset Quadrature Amplitude Modulation) is a FBMC technique in which data on each subcarrier is shaped with an appropriately designed pulse so that side lobes are significantly reduced. In OFDM-OQAM, a QAM symbol's real in-phase and quadrature components are time offset with respect to each other by one half of a symbol interval, and are transmitted in the same subcarrier. Adjacent subcarriers overlap to maximize the spectral efficiency, creating inter-carrier interference (ICI). In addition, several consecutive OFDM-OQAM symbols interfere with each other due to the long pulse, creating inter-symbol interference (ISI). In a distortion-free channel, orthogonality can be achieved with a proper transceiver architecture, which can be efficiently implemented with polyphase filters.

Faster-than-Nyquist (FTN) signaling refers to signaling where the time and/or frequency spacing of the waveform is chosen such that pulses appear at a rate faster than the Nyquist rate at which inter-carrier and/or inter-symbol interference is zero under ideal channel conditions. In other words, more pulses are packed into the time/frequency grid than the Nyquist rate, resulting in non-orthogonal waveforms and self-interference. The self-interference can be cancelled at the receiver. Since, in FTN, more pulses are transmitted in the same time/frequency resource, throughput can be increased.

### SUMMARY

The disclosure pertains to methods and apparatus for Faster Than Nyquist modulation schemes to increase throughput in multicarrier communication systems wherein the latency problem inherent in filter bank multicarrier systems is reduced or eliminated by using non-orthogonal waveforms (i.e., faster than Nyquist modulation) in only part(s) of the subframe and orthogonal waveforms in other part(s). The number and spacing between FTN pulses may be selected such that the last sample of the last pulse is received within the time slot allocated to the corresponding subframe/packet, thereby eliminating added latency.

FTN signaling also may be used as a method to control/coordinate interference between different nodes whose transmissions potentially interfere with each other. For instance, if a node uses FTN, more pulses may be packed into a given period in the time domain. Since, in this case, more resources are available in the time domain, fewer resources in the frequency domain may be needed. Therefore, some parts of the band, e.g., subchannels, may be left unused (or used with reduced transmission power). These subchannels may be used by the other nodes. The interference control/coordination may be extended to time and/or frequency. The FTN schemes disclosed herein may be used with different types of multicarrier systems.

### BRIEF DESCRIPTION OF THE DRAWINGS

A more detailed understanding may be had from the following description, given by way of example, in conjunction with the accompanying drawings wherein:

FIG. 1 is a block diagram of a FBMC transmitter and receiver pair;

FIG. 2 is a timing diagram illustrating FTN compared to an orthogonal modulation scheme;

FIG. 3 is a time and frequency diagram illustrating the use of vacated spectrum for interference cancellation/coordination among different transmitters;

FIGS. 4A and 4B show a pair of timing diagrams illustrating several options for FTN modulation schemes in accordance with embodiments;

FIG. 5A is a system diagram of an example communications system in which one or more disclosed embodiments may be implemented;

FIG. 5B is a system diagram of an example wireless transmit/receive unit (WTRU) that may be used within the communications system illustrated in FIG. 5A; and,

FIGS. 5C-5E are system diagrams of an example radio access networks and example core networks that may be used within the communications system illustrated in FIG. 5A.

### DETAILED DESCRIPTION

### 1 Overview

One potential disadvantage of FBMC is the large latencies introduced by long filters. Particularly, the receiver typically must wait to receive all the samples of the last filtered pulse transmitted before processing the signal to recover the symbols. As a result, if the length of a subframe is fixed (as it is in LTE, for example), the receiver must wait an additional period of time proportional to the length of the filter to receive the whole subframe before processing the signal to recover the symbols.

One possible solution includes reducing the filter length. However, this solution results in larger spectral leakage. Another possible solution is to not transmit the last several pulses. However, this solution results in significant throughput loss.

In accordance with an aspect of some embodiments, the latency problem is eliminated by using non-orthogonal waveforms in only part(s) of the subframe and orthogonal waveforms in other part(s). More particularly, reduction or elimination of latency with non-orthogonal waveforms is achieved through the use of a combination of pulses that are transmitted at or below the Nyquist rate and pulses that are transmitted faster than the Nyquist rate within a subframe/packet. The number and spacing between FTN pulses is selected such that the last sample of the last pulse is received within the time slot allocated to the subframe/packet. Coding and interleaving of data is performed over the whole subframe/packet so that the loss in Bit Error Rate (BER) is minimized. A similar compression can be incorporated into the frequency spacing of the subcarrier channels. That is, the frequency spacing between some pairs of adjacent subcarriers can be at non-FTN spacing (i.e., spaced apart at frequency spacings at or greater than the spacing needed to avoid interference between adjacent subcarriers), while others are not (i.e., other adjacent subcarriers are spaced more closely together such that there is intercarrier interference (ICI)). In the context of frequency spacing (as opposed to temporal spacing) of pulses, FTN means that adjacent subcarrier frequencies are spaced apart at frequency intervals that are smaller than necessary to assure frequency orthogonality of the two channels. Nevertheless, the term FTN is sometimes used herein in connection with both frequency spacing and temporal spacing.

Interference coordination is another fundamental issue in virtually all wireless communications. There have been many techniques proposed to manage and control interference among separate transmitters.

In accordance with another aspect, FTN signaling also may be used as a method to control/coordinate interference between different nodes. Specifically, as an example, if a node uses FTN, more pulses may be packed into a given period in the time domain and/or more frequency channels can be packed into a given bandwidth. As a result, some of the time/frequency resources may not be needed and those resources may be kept unused (or may be used with reduced transmission power). Other users, then may utilize these resources, resulting in no or reduced interference.

More particularly, interference coordination with non-orthogonal waveforms may comprise a transmitter transmitting at faster than the Nyquist rate (FTN) at least some of the time and/or in part of the frequency band. The reduction in transmission resources used to transmit a given signal that is inherent to an FTN modulation scheme enables the transmitter to vacate certain time/frequency resources. The newly created vacant resources may then be used by other, e.g., interfering, node(s). Alternately, they may be used by the same node for additional communication channels. The decision as to which resources will be freed may be controlled either by a central controller or in a distributed manner. For example, in one example of a distributed technique, one node may switch from an orthogonal modulation scheme to a FTN scheme, thereby freeing some time and/or frequency resources. A second node may detect the freed resources using any of several well-known sensing mechanisms, e.g., energy detection. If the energy level in a specific resource is below a threshold, this resource may be used by the second node.

### 2 FTN MCM for Interference Control/Coordination

For a general multicarrier modulation scheme, the input data sequence to be transmitted on the k^{th} subcarrier and n^{th} symbol may be denoted as xₖ[n]. Then, the input transmitted signal can be written as

$$y ( t ) = {\sum }_{k = 0}^{M - 1} {\sum }_{n = - ∞}^{∞} {x}_{k} [ n ] g ( y - {nT}_{0} ) {e}^{j2π {kF}_{s} t} \qquad ( 1 )$$

where g(t) is the prototype filter, T₀ is the symbol interval, M is the total number of subcarriers, and Fₛ [symbol] 1/T₀ is the spacing between the subcarriers. For OFDM-OQAM, the input data symbols are separated into real and imaginary parts and are transmitted with pulses separated by half a symbol interval. The OFDM-OQAM transmitted signal can be written as shown in equation (2) below (P. Siohan, C. Siclet and N. Lacaille “Analysis and design of OFDM/OQAM systems based on filter bank theory”, IEEE Trans. Signal Process., vol. 50, pp. 1170-1183, 2002):

$$y ( t ) = {\sum }_{k = 0}^{M - 1} {\sum }_{n} {e}^{{jθ}_{k , n}} {x}_{k}^{R} [ n ] g ( t - n \frac{{T}_{0}}{2} ) {e}^{j2π {kF}_{s} t} \\ where {θ}_{k , n} = \frac{π}{2} ( k + n ) . \qquad ( 2 )$$

For orthogonal MCM, the sampling frequency and symbol timing satisfy the relationship T₀Fₛ=1. A signaling system is said to be faster-than-Nyquist if the pulses appear at a rate beyond the allowed Nyquist condition for ISI-free transmission. See, for example, J. E. Mazo, “Faster-than-Nyquist signaling,” Bell Syst. Tech. J., October 1975 and Dasalukunte, D.; Rusek, F.; Öwall, V., “Multicarrier Faster-Than-Nyquist Transceivers: Hardware Architecture and Performance Analysis,” Circuits and Systems I: Regular Papers, IEEE Transactions on, vol. 58, no. 4, pp. 827,838, April 2011. FTN signaling is a method of improving bandwidth efficiency of conventional orthogonal modulation schemes. Since pulses are transmitted at a rate faster than the Nyquist rate and in channels that overlap each other, there is induced interference in both time and frequency, generally referred to as intersymbol (ISI) and intercarrier interference (ICI), respectively.

If ΔT and ΔF define the compression, such that (ΔTTₒ)(ΔFFₛ)<1, then equation (1) can be expressed as shown in equation (3) when representing the transmitted signal of an FTN MCM scheme.

$$y ( t ) = {\sum }_{k = 0}^{M - 1} {\sum }_{n = - ∞}^{∞} {x}_{k} [ n ] g ( t - n ( Δ T {T}_{0} ) ) {e}^{j2π k ( Δ {FF}_{s} ) t} \qquad ( 3 )$$

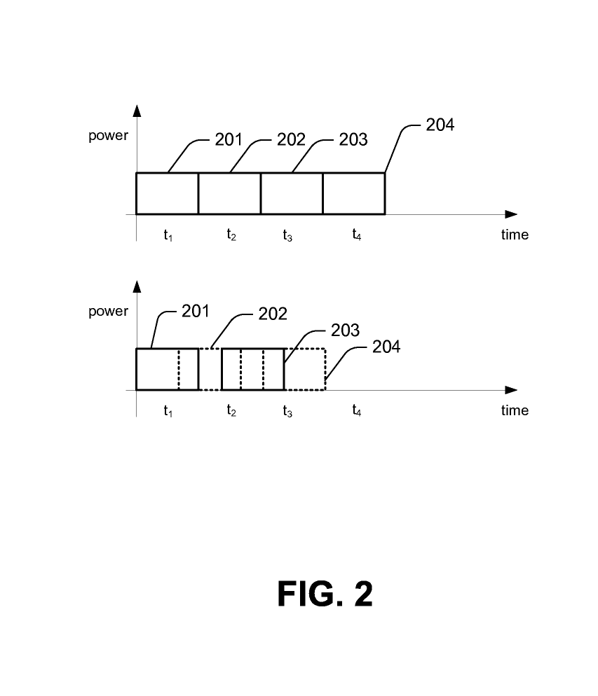

FIG. 2 illustrates the concept of FTN. Note that this figure illustrates a single subchannel so that time is represented by the horizontal axis and power is represented by the vertical axis and frequency is not represented explicitly in the figure. The top portion of the figure illustrates four temporally orthogonal pulses 201, 202, 203, 204, e.g., as in OFDM. The pulses are represented as perfect rectangular pulses and as identical for sake of simplicity in illustration. However, it will be well understood that actual pulses will not be perfectly rectangular and, when the pulses carry actual data, they are not likely to be identical.

The same four pulses in an FTN modulation scheme in which ΔT<1 and ΔF is unchanged are shown in the bottom portion of the figure. The first and third pulse 201, 203 are indicated by solid lines, while the second and fourth pulses 202, 204 are indicated by dashed lines strictly to help visually distinguish the pulses from each other in the FIG. It can be seen that, in this case, the pulses are transmitted at a higher rate, resulting in an increase of the throughout (assuming that the created self-interference may be (partially) cancelled at the receiver).

If the throughput of the entire transmission scheme is kept unchanged, then one may be able to free some of the subchannels, i.e., ΔF>1, whereby the vacated subcarriers are available for use by another node potentially interfering with this node.

Alternately, one may keep ΔF=1, but use less than the total available bandwidth and keep the remaining bandwidth unused, whereby the vacated part of the spectrum is available for use by another node, potentially one that is interfering with this node.

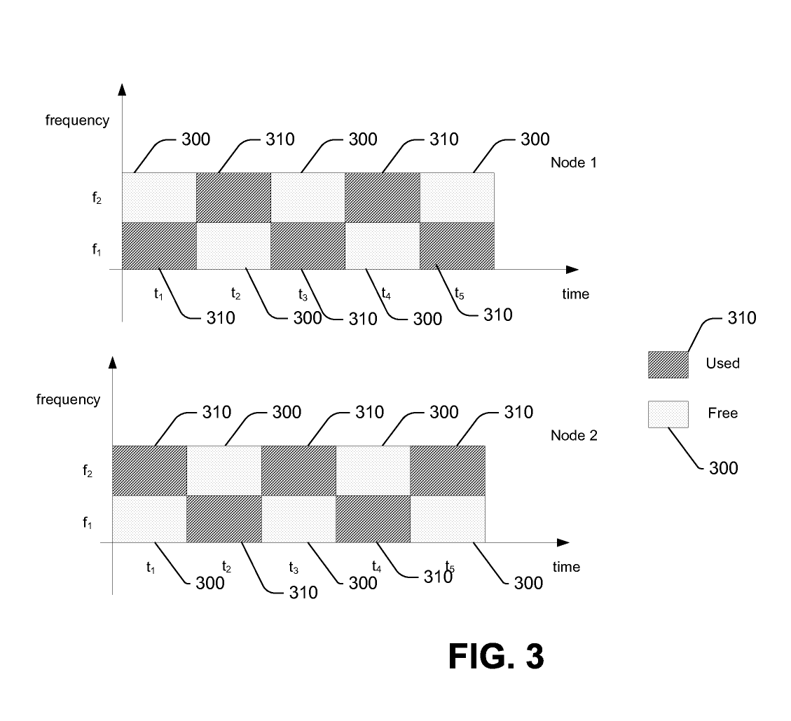

In general, the transmitter now can utilize less than the whole bandwidth since more data is being squeezed into the available time resources. The underutilized frequency may be used for interference cancellation/coordination among different transmitters. FIG. 3 illustrates the idea. In FIG. 3, time is represented on the horizontal axis and frequency (or different carriers/subcarriers/channels) is represented on the vertical axis. FIG. 3 shows the same time and frequency resources for two different nodes of a network, namely frequency subcarriers f₁ and f₂ and time slots t₁-t₅. The dark rectangles 300 represent time and frequency resources that are being used by the particular transmitter, while the lighter rectangles 310 represent time and frequency resources that are not being used by the particular transmitter. The frequency resources not used by one transmitter may be used by another transmitter. In general, separate transmitters may try to utilize disjointed sets of frequency resources as much as possible.

Several methods are possible to enable coordination between transmitters. In one case, if the system has a central controller, such as a base station in a cellular system, the controller may signal the available resources to the individual transmitters. Alternately, if the transmitters are base stations themselves, they may exchange some control information. In another case, if the system is distributed, then transmitters may use a sensing technique such as energy detection to find vacant resources that they can use. The availability of these resources is not expected to change from packet to packet since traffic requirements do not change abruptly.

The above examples may be generalized so that ΔT and ΔF are selected to optimize the system throughout. For example, in one case, subcarriers may be packed in frequency domain and resources in time may be underutilized.

### 3 FTM MCM for Latency Reduction

As noted above, a disadvantage of FBMC is the additional latency introduced by the use of long filters. The receiver has to wait to receive all the samples of the last filtered pulse transmitted. Due to this, if the length of a subframe is fixed, e.g. as in LTE, the receiver has to wait an additional period of time to receive the whole subframe. For example, assume a LTE system with FFT size of 1024 (i.e., an OFDM symbol consists of 1024 samples (not considering the cyclic prefix)). If the OFDM-OQAM filter length is 4096 (1024×4), compared to OFDM, the receiver will have to wait to receive 4096−1024=3072 additional samples that correspond to the duration of 3 OFDM symbols. This is the additional latency.

The latency may be reduced with several methods. The most straightforward method is to use a shorter filter. However, shorter filters will provide less out-of-band emission reduction than longer filters. Another method is to transmit fewer symbols such that the final sample of the last transmitted symbol is received within the time slot of the subframe. However, this method will result in loss of much of the throughput gain achieved by use of FTN.

In accordance with an embodiment, the latency is eliminated or reduced by using non-orthogonal waveforms (i.e., FTN) in only a portion of a subframe/packet. The idea is based on a combination of pulses transmitted at (or below) the Nyquist rate and pulses transmitted at faster than Nyquist rate. The modulation scheme for a subframe packet may be configured as a combination of pulses transmitted at a higher rate than the Nyquist rate and pulses transmitted at (or below) the Nyquist rate such that the last sample of the last pulse is received within the time slot provided by the communication system for the subframe. What this essentially means is that, the FTN MCM may be generalized as follows:

$$y ( t ) = {\sum }_{k = 0}^{M - 1} {\sum }_{n = - ∞}^{∞} {x}_{k} [ n ] g ( t - n ( Δ {T}_{k , n} {T}_{0} ) ) {e}^{j2π k ( Δ {F}_{k , n} {F}_{s} ) t} \qquad ( 4 )$$

This means that ΔT and ΔF are potentially functions of the symbol and subchannel indices n and k. This should be contrasted with equation (3), in which ΔT and ΔF were constants. This scheme provides the flexibility of packing more pulses in only certain time/frequency resources.

The values for ΔT_{k,n} and ΔF_{k,n} should be known a priori by both the transmitter and receiver so that decoding may be possible. This can be achieved in any number of ways, including, preprogramming of the transmitter and the receiver with predetermined values, the transmitter transmitting such data to the receiver in a control channel prior to transmitting the payload data in a payload channel, and a base station or other network node transmitting the values to the transmitter and the receiver on a control channel prior to commencing FTN communication between the transmitter and the receiver.

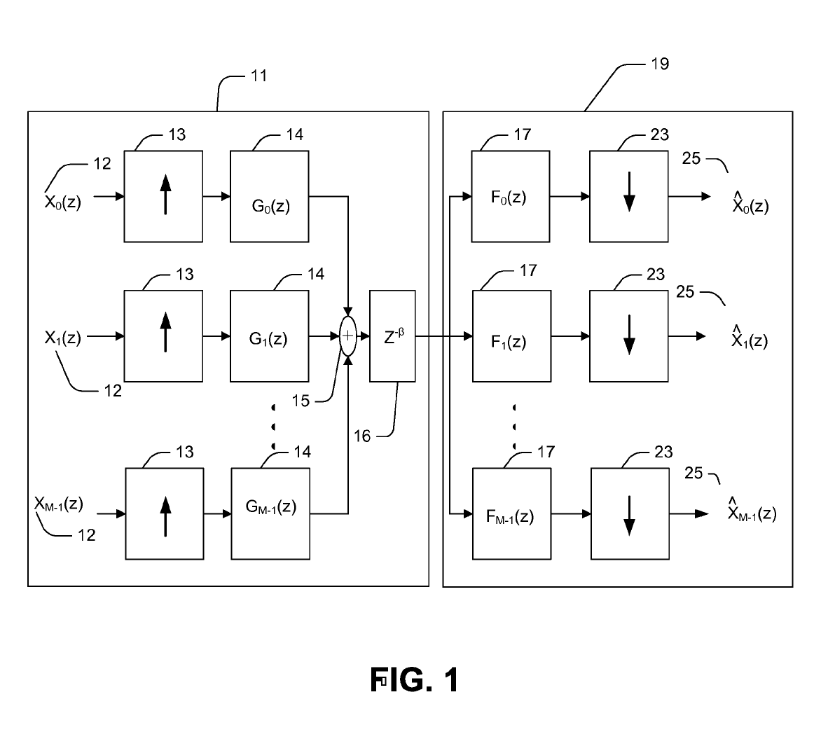

The values for ΔT_{k,n} and ΔF_{k,n} may be established in the transmitter and the receiver in any physical or functional component and/or in any manner known in the art or heretofore discovered for setting Tₒ and Fₛ in any filter bank multicarrier modulation scheme. Merely as examples, the temporal spacing between pulses in a subcarrier can be set in the upsampler (see FIG. 1, for example) or in the analog-to-digital/digital-to-analog conversion processes. The frequency spacing between the subcarriers may be established within the filters themselves (see FIG. 1) or in other components of the devices.

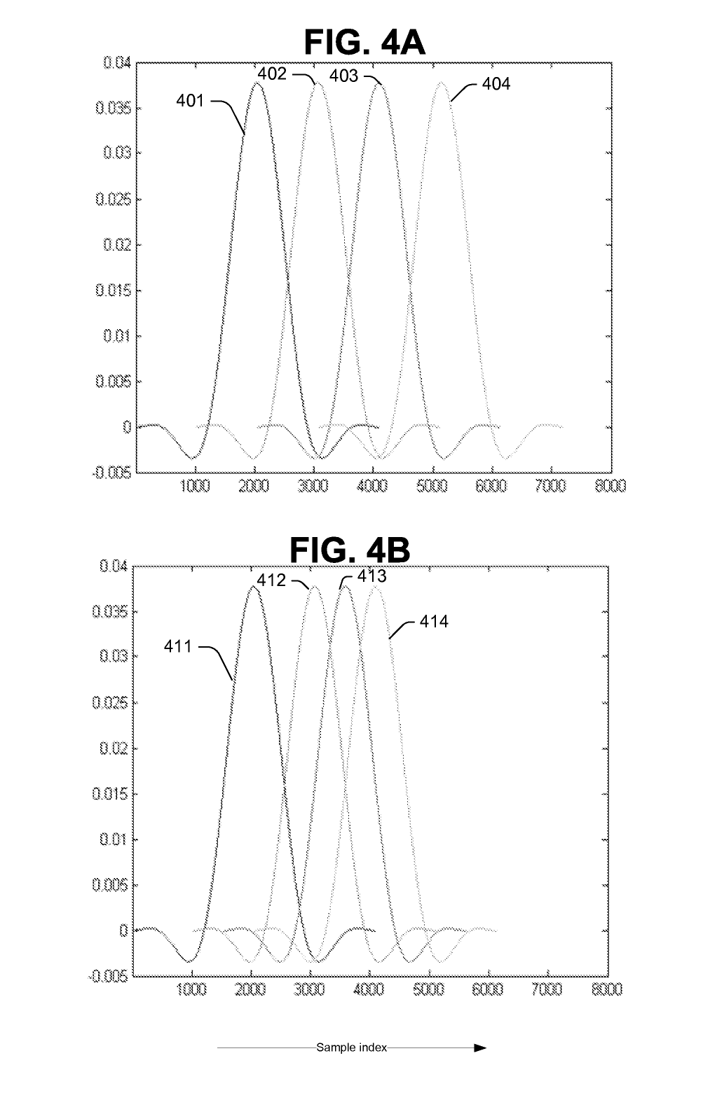

FIGS. 4A and 4B help illustrate the proposed scheme. FIG. 4A shows four consecutive pulses 401, 402, 403, 404, transmitted in a given subcarrier channel at the Nyquist rate. In order not to obfuscate the drawing, this figure illustrates all four pulses as identical (e.g., showing only the pulses without data on them or each containing identical data in the sense that all pulses are of the same amplitude and zero phase shift). The length of each pulse is 4096 samples while ΔT is set to 1024 samples for all pulses. In FIG. 4B, ΔT between the first and second pulses 411 and 412 is 1024 samples, but ΔT between the second and third pulses 412 and 413 and between the third and fourth pulses 413, 414 is 512 samples each instead of 1024 samples. Therefore, these pulse are considered to be FTN because they overlap with each other in a manner that the value sampled at the receiver will be dictated by a combination of two pulses (i.e., they interfere with each other). In this example, the last sample of the fourth pulse 414 in FIG. 4B is transmitted 1024 samples earlier in time than the last sample of the fourth pulse in FIG. 4A. This is due to the halving of ΔT to 512 samples after the second pulse is transmitted.

By collectively setting the ΔT between all of the pulses so that the last pulse in the subframe is received within the time slot provided by the communication system for the subframe, no latency is introduced by the FTN modulation scheme.

The variations in ΔT can take on almost any form, e.g., ΔT increasing (steadily or otherwise) during the subframe, ΔT decreasing (steadily or otherwise) during the subframe, ΔT increasing at first and then decreasing during the subframe, etc., as long as the last the last pulse in the subframe is received within the time slot provided by the communication system for the subframe, no latency is introduced by the FTN modulation scheme.

The non-orthogonality introduced in the FTN scheme will bring additional interference that should be addressed at the receiver. However, since the interference is known (assuming channel knowledge), then the loss, measured, for instance, as BER (Bit Error Rate), is not significant. See, e.g., B. Farhang-Boroujeny, “OFDM Versus Filter Bank Multicarrier,” Signal Processing Magazine, IEEE, vol. 28, no. 3, pp. 92-112, May 2011. In addition, the data transmitted are coded and interleaved over the whole subframe, i.e., over all pulses that are transmitted at, below, or faster than the Nyquist rate. Thus, losses due to the interference will be limited.

The receiver for a FTN transmitter may be based on interference cancellation. If both Nyquist rate and FTN pulses are transmitted, the performance of the receiver may be improved by first detecting the symbols transmitted on the Nyquist pulses, regenerating those pulses, and then subtracting the regenerated pulses from the packet. This will leave only the FTN pulses remaining, which can then be detected in another detection operation just for the FTN pulses.

### 4 Networks for Implementation

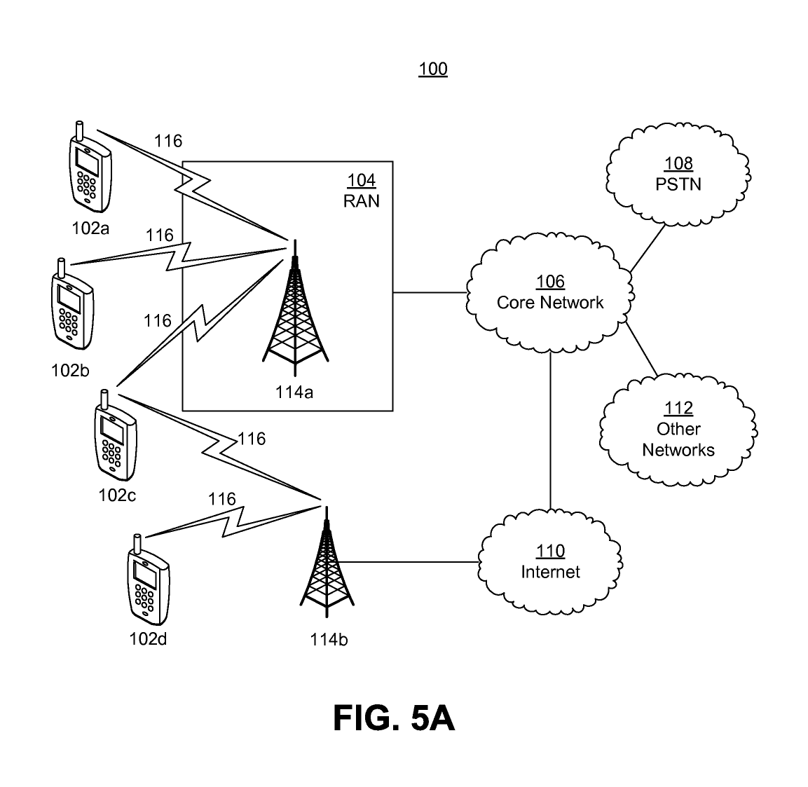

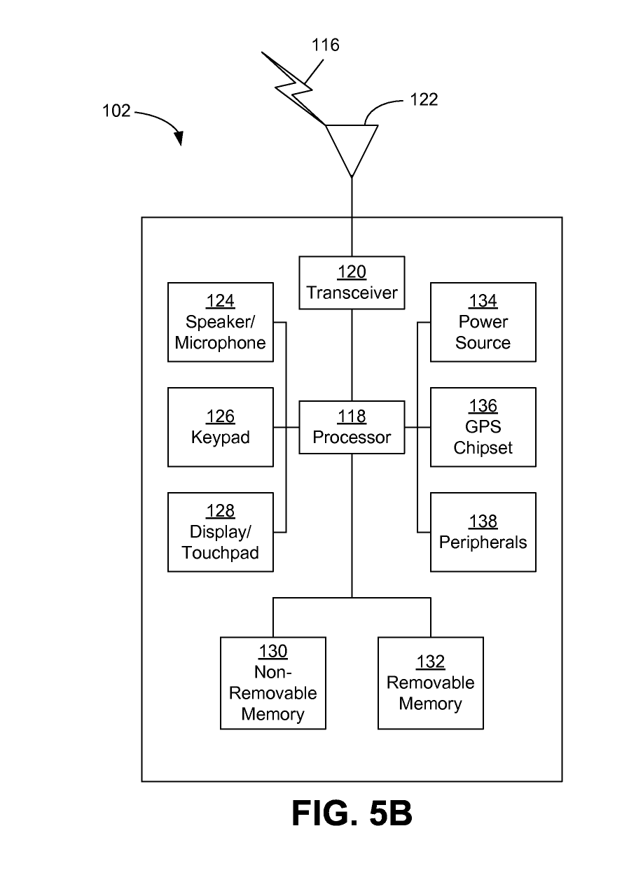

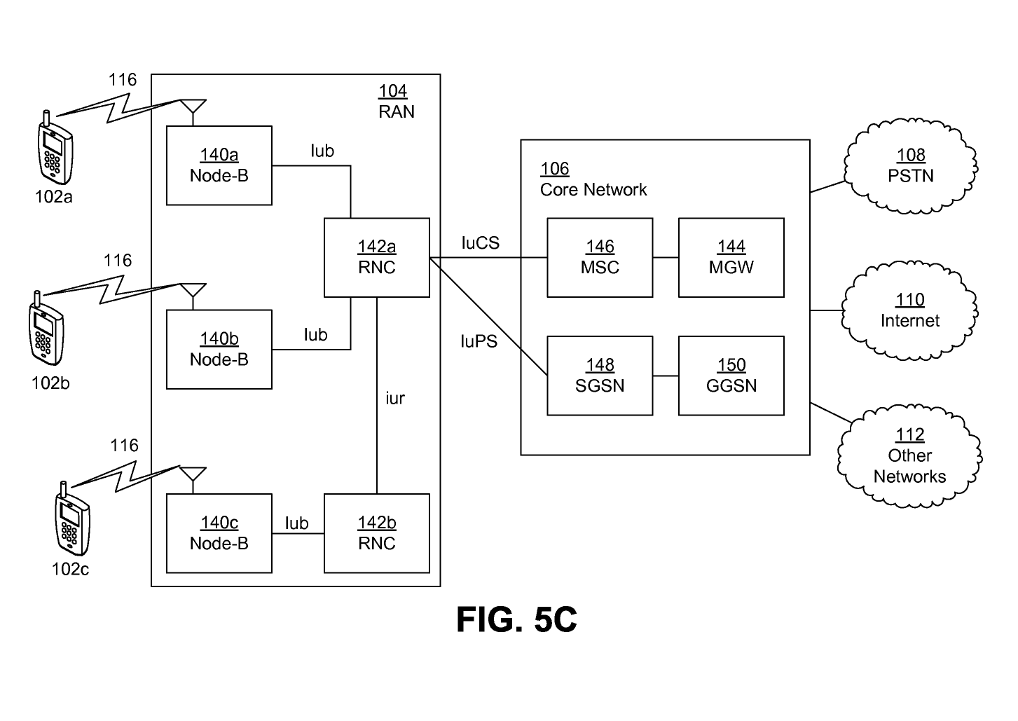

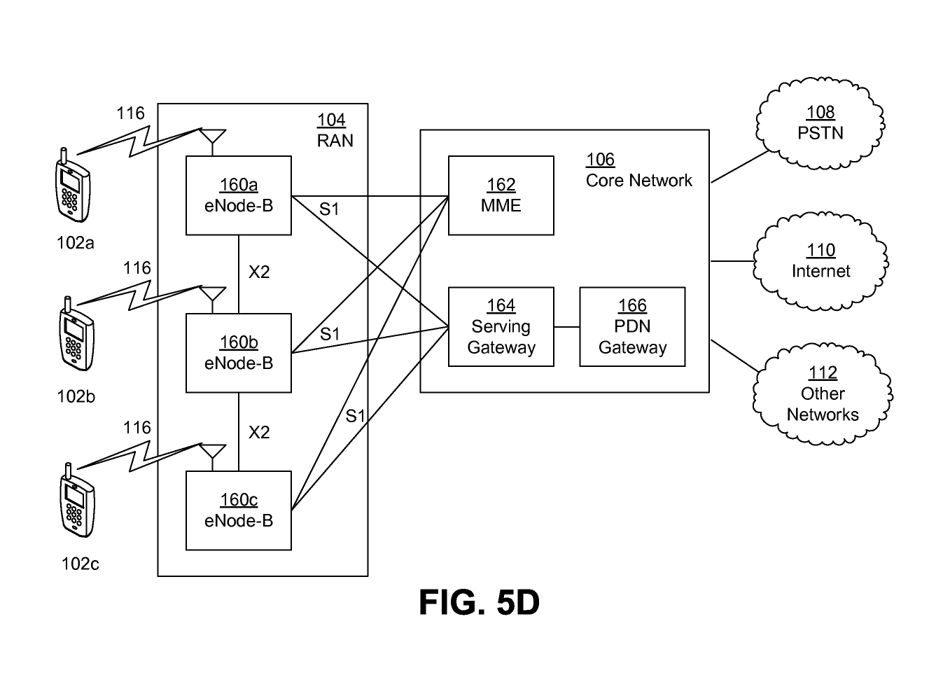

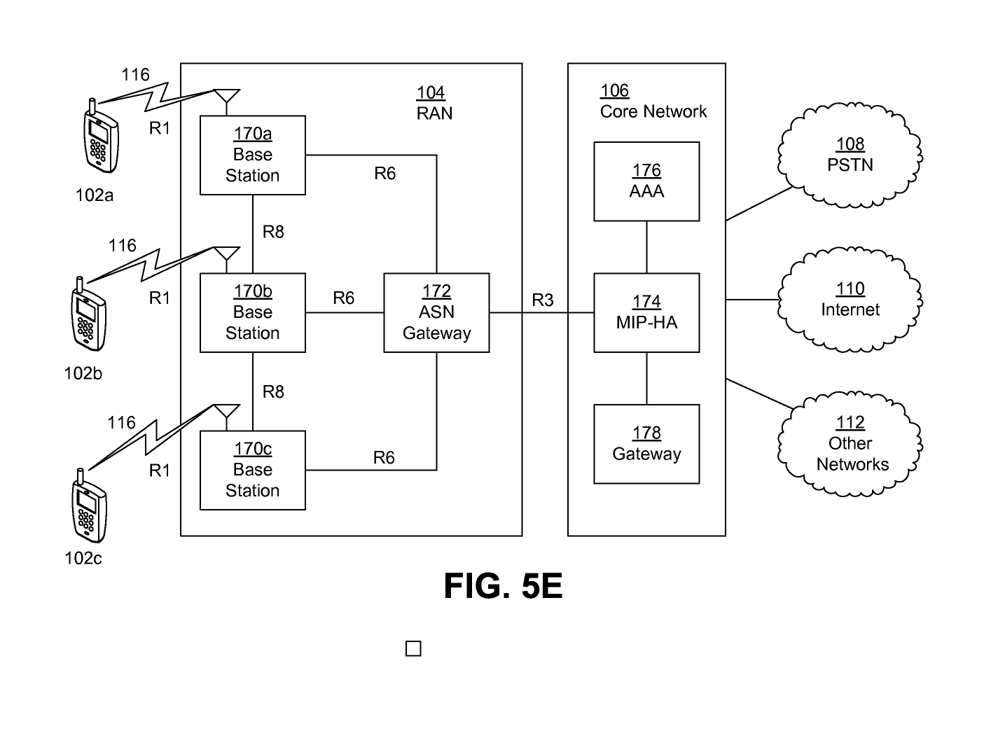

FIG. 5A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 5A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 5A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 5A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 5A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 5A may be configured to communicate with the base station 114a, which may employ a cellular-based radio technology, and with the base station 114b, which may employ an IEEE 802 radio technology.

FIG. 5B is a system diagram of an example WTRU 102. As shown in FIG. 5B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 5B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 5B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality, and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 5C is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 5C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 5C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 5C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 5D is a system diagram of the RAN 104 and the core network 106 according to another embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 5D, the eNode-Bs 160a, 160b, 160c may communicate with one another over an X2 interface.

The core network 106 shown in FIG. 5D may include a mobility management gateway (MME) 162, a serving gateway 164, and a packet data network (PDN) gateway 166. While each of the foregoing elements are depicted as part of the core network 106, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 5E is a system diagram of the RAN 104 and the core network 106 according to another embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 5E, the RAN 104 may include base stations 170a, 170b, 170c, and an ASN gateway 172, though it will be appreciated that the RAN 104 may include any number of base stations and ASN gateways while remaining consistent with an embodiment. The base stations 170a, 170b, 170c may each be associated with a particular cell (not shown) in the RAN 104 and may each include one or more transceivers for communicating with the WTRUs 102a, 102b, 102c over the air interface 116. In one embodiment, the base stations 170a, 170b, 170c may implement MIMO technology. Thus, the base station 170a, for example, may use multiple antennas to transmit wireless signals to, and receive wireless signals from, the WTRU 102a. The base stations 170a, 170b, 170c may also provide mobility management functions, such as handoff triggering, tunnel establishment, radio resource management, traffic classification, quality of service (QoS) policy enforcement, and the like. The ASN gateway 172 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 170a, 170b, 170c may be defined as an R8 reference point that includes protocols for facilitating WTRU handovers and the transfer of data between base stations. The communication link between the base stations 170a, 170b, 170c and the ASN gateway 172 may be defined as an R6 reference point. The R6 reference point may include protocols for facilitating mobility management based on mobility events associated with each of the WTRUs 102a, 102b, 100c.

As shown in FIG. 5E, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 174, an authentication, authorization, accounting (AAA) server 176, and a gateway 178. While each of the foregoing elements are depicted as part of the core network 106, it will be appreciated that any one of these elements may be owned and/or operated by an entity other than the core network operator.

The MIP-HA 174 may be responsible for IP address management, and may enable the WTRUs 102a, 102b, 102c to roam between different ASNs and/or different core networks. The MIP-HA 174 may provide the WTRUs 102a, 102b, 102c with access to packet-switched networks, such as the Internet 110, to facilitate communications between the WTRUs 102a, 102b, 102c and IP-enabled devices. The AAA server 176 may be responsible for user authentication and for supporting user services. The gateway 178 may facilitate interworking with other networks. For example, the gateway 178 may provide the WTRUs 102a, 102b, 102c with access to circuit-switched networks, such as the PSTN 108, to facilitate communications between the WTRUs 102a, 102b, 102c and traditional land-line communications devices. In addition, the gateway 178 may provide the WTRUs 102a, 102b, 102c with access to the networks 112, which may include other wired or wireless networks that are owned and/or operated by other service providers.

Although not shown in FIG. 5E, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

### 5 Conclusion

Throughout the disclosure, one of skill understands that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WRTU, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

No element, act, or instruction used in the description of the present application should be construed as critical or essential to the invention unless explicitly described as such. In addition, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Further, as used herein, the term “set” is intended to include any number of items, including zero. Further, as used herein, the term “number” is intended to include any number, including zero.

Moreover, the claims should not be read as limited to the described order or elements unless stated to that effect. In addition, use of the term “means” in any claim is intended to invoke 35 U.S.C. §112, ¶6, and any claim without the word “means” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WRTU), user equipment (UE), terminal, base station, Mobility Management Entity (MME) or Evolved Packet Core (EPC), or any host computer. The WRTU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1. A method of filter bank multicarrier modulation of an input signal comprising:
receiving a plurality of streams of symbols, each stream for transmission on a different carrier frequency; and
modulating each stream of symbols onto a respective carrier frequency such that, in each modulated stream, some of the symbols are temporally spaced at a rate faster than a Nyquist rate and some of the symbols are temporally spaced at or below the Nyquist rate.

2. The method of claim 1 wherein each modulated stream comprises at least one data packet, each data packet comprising a plurality of symbols and being assigned a duration for transmission, and wherein the symbols in each packet are modulated such that, in each packet, some of the symbols are temporally spaced at a rate faster than the Nyquist rate and some of the symbols are temporally spaced at or below the Nyquist rate such that the overall time required to transmit each packet is not greater than the assigned duration.

3. The method of claim 2 wherein the packets comprise subframes in a communication system.

4. The method of claim 1 further comprising:
upsampling each stream;
filtering each stream; and
summing the streams.

5. The method of claim 2 further comprising:
transmitting to a receiver of the modulated data streams an indication of the spacing of the symbols in the modulated data streams.

6. The method of claim 2 further comprising:
receiving from the network an indication of the time and/or frequency spacing to be used between symbols.

7. The method of claim 1 wherein each transmitted modulated data stream is:
$$y ( t ) = {\sum }_{k = 0}^{M - 1} {\sum }_{n = - ∞}^{∞} {x}_{k} [ n ] g ( t - n ( Δ {T}_{k , n} {T}_{0} ) ) {e}^{j2π k ( Δ {F}_{k , n} {F}_{s} ) t}$$
wherein
y(t) is the transmitted modulated data stream;
t is time;
g(t) is a filter function;
T₀ is the symbol interval at Nyquist rate;
xₖ[n] is the input data sequence to be transmitted on the k^{th} subcarrier and n^{th} symbol;
M is the total number of subcarriers;
Fₛ [symbol] 1/T₀ is the spacing between the carriers at Nyquist spacing;
ΔT_{k,n} is the temporal compression between the n^{th} symbol and the (n−1)^{th} symbol on the k^{th} subcarrier relative to the Nyquist rate expressed as a fraction of the Nyquist rate; and
ΔF_{k,n} is the frequency compression between the k^{th} carrier and the (k−1)^{th} carrier of the n^{th} symbol relative to the Nyquist frequency separation expressed as a fraction of the Nyquist frequency separation rate.

8. The method of claim 2 wherein the frequency spacing between adjacent pairs of the carrier frequencies is such that some adjacent pairs of the carrier frequencies are spaced apart so as not to meet a Nyquist frequency spacing condition and other adjacent pairs of carrier frequencies are spaced apart so as to meet or exceed the Nyquist frequency spacing condition.

9. A method of filter bank multicarrier processing of a received signal comprising:
receiving a wireless signal comprising a plurality of streams of symbols on different carrier frequencies, in which each of the plurality of streams comprises some symbols that are temporally and/or frequency spaced at a rate that is faster than a Nyquist rate and some symbols are temporally and/or frequency spaced at a rate that is at or below the Nyquist rate;
frequency demultiplexing the wireless signal into the plurality of data streams in accordance with the frequency spacings of the plurality of data streams;
filtering each data stream; and
detecting the symbols in each data stream in accordance with the temporal spacing of the symbols in each data stream.

10. (canceled)

11. A filter bank multicarrier modulator apparatus comprising:
a processor configured to:
receive a plurality of streams of symbols, each stream for transmission on a different carrier frequency; and
modulate each stream of symbols onto a respective carrier frequency such that, in each modulated stream, some of the symbols are temporally spaced at a rate faster than a Nyquist rate and some of the symbols are temporally spaced at or below the Nyquist rate.

12. The filter bank multicarrier modulator apparatus of claim 11 wherein each modulated stream comprises at least one data packet, each data packet comprising a plurality of symbols and being assigned a duration for transmission, and wherein the processor is further configured to modulate the symbols in each packet such that, in each packet, some of the symbols are temporally spaced at a rate faster than the Nyquist rate and some of the symbols are temporally spaced at a rate at or below the Nyquist rate such that the overall time required to transmit each packet is not greater than the assigned duration.

13. The filter bank multicarrier modulator apparatus of claim 12 wherein the packets comprise subframes in the communication system.

14. The filter bank multicarrier modulator apparatus of claim 11 wherein the processor is further configured to upsample each stream, filter each stream, and combine the streams.

15. The filter bank multicarrier modulator apparatus of claim 11 wherein each transmitted modulated data streams is:
$$y ( t ) = {\sum }_{k = 0}^{M - 1} {\sum }_{n = - ∞}^{∞} {x}_{k} [ n ] g ( t - n ( Δ {T}_{k , n} {T}_{0} ) ) {e}^{j2π k ( Δ {F}_{k , n} {F}_{s} ) t}$$
wherein
y(t) is the transmitted modulated data stream;
t is time;
g(t) is a filter function;
T₀ is the symbol interval at Nyquist rate;
xₖ[n] is the input data sequence to be transmitted on the k^{th} subcarrier and n^{th} symbol;
M is the total number of subcarriers;
Fₛ [symbol] 1/T₀ is the spacing between the carriers at Nyquist spacing;
ΔT_{k,n} is the temporal compression between the n^{th} symbol and the (n−1)^{th} symbol on the k^{th} subcarrier relative to the Nyquist rate expressed as a fraction of the Nyquist rate; and
ΔF_{k,n} is the frequency compression between the k^{th} carrier and the (k−1)^{th} carrier of the n^{th} symbol relative to the Nyquist frequency separation expressed as a fraction of the Nyquist frequency separation rate.

16. The method of claim 11 wherein the processor is further configured to establish a frequency spacing between adjacent pairs of the carrier frequencies such that some adjacent pairs of the carrier frequencies are spaced apart so as not to meet a Nyquist frequency spacing condition and other adjacent pairs of carrier frequencies are spaced apart so as to meet the Nyquist frequency spacing condition.
